(19) United States
(12) Patent Application Publication
(10) Pub. No.: US 2007/0046699 A1
(43) Pub. Date: Mar. 1, 2007

(54) Three dimensional adorner

(75) Inventors: Henry A. Sowizral, Redmond, WA (US); Kurt B. Jacob, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/217,810

(22) Filed: Sep. 1, 2005

(51) Int. Cl. G09G 5/00

(52) U.S. Cl. 345/661

(57) ABSTRACT

A three dimensional adorner may be displayed with a corresponding three dimensional object when the object is created or inserted into a display and also at any subsequent time that the object is selected. Additionally, if any portions of the adorner are obscured, the adorner may be reoriented such that the obscured portions are made accessible. Distortion of the adorner in a perspective view may be reduced by removing the adorner from the perspective view, regenerating the adorner in an orthographic view, and then merging the orthographic view of the regenerated adorner with the perspective view of the corresponding object.

### BACKGROUND

Conventional three dimensional editing tools provide a variety of controls for manipulating a three dimensional object. One such control is a three dimensional adorner, which enables a number of different types of transformation operations to be performed on the object without the need to constantly switch between controls. Such transformation operations may include translation, rotation, scaling and other operations. An exemplary three dimensional object 10 and corresponding three dimensional adorner 20 are shown in FIG. 1. The adorner 20 has three axes portions 21a-c each positioned along a corresponding half axis and extending a fixed and equivalent distance from a center point 11 of object 10. The three half axes are the positive X, positive Y, and positive Z half axes. Each axis portion 21a-c terminates with a corresponding arrow portion 24a-c. Additionally, adorner 20 has three cube portions 22a-c, each positioned on a corresponding axis portion at a fixed and equivalent distance from center point 11. Furthermore, adorner 20 has three arc portions 23a-c, each connecting two of the cube portions. The corresponding arc portion for each axis connects the two cube portions of the two non-corresponding axes. For example, X arc portion 21a connects Y cube portion 22b and Z cube portion 22c. Although not depicted in FIG. 1, adorner 20 may be color coded such that portions associated with each axis are given a unique color. For example, X axis associated portions 21a-24a may be colored in blue, Y axis associated portions 21b-24b may be colored in green, and X axis associated portions 21c-24c may be colored in red.

Each portion of adorner 20 may enable a particular operation to be performed on object 10. Specifically, clicking and dragging one of arrow portions 24a-c or shaft portions 21a-c with an attached mouse may cause object 10 to be translated along an associated axis. For example, clicking and dragging X arrow portion 24a may cause object 10 to be translated along the X axis. Additionally, clicking and dragging one of cube portions 22a-c may cause object 10 to be scaled along an associated axis. Furthermore, clicking and dragging one of arc portions 23a-c may cause object 10 to be rotated about an associated axis. Thus, a number of different transformation operations may be performed on object 10 using adorner 20 rather than a combination of different modes and tools. For example, without adorner 20, an editing tool may require a separate translation tool, a separate scaling tool, and a separate rotation tool.

There are, however, a number of limitations associated with the use of three dimensional adorners. One such limitation is that the adorner may only be displayed when its associated object is first created or inserted into a display. The adorner may then disappear and become inaccessible as soon as the creation step is complete. This premature removal of the adorner presents many inconveniences. For example, if a user wishes to manipulate the object after the creation step is complete, then the user may be forced to switch between a variety of different tools to perform the manipulations that could otherwise be performed with only the adorner.

Another limitation associated with three dimensional adorners is that an object may become positioned such that one or more portions of its corresponding adorner cannot be easily viewed or accessed, thereby making it difficult to perform the operations associated with those portions of the adorner. In particular, this may occur when the adorner is positioned such that some portions of the adorner overlay and obscure underlying portions of the adorner. In some cases, underlying portions of the adorner may be completely obscured and inaccessible. An exemplary partially obscured adorner is shown in FIG. 2. Object 10, a bull, is positioned such that several portions of adorner 20 are completely or partially obscured. These obscured portions include X axis portion 21a, X cube portion 22a, X arrow portion 24a, Y arc portion 23b, and Z arc portion 23c (all not referenced in FIG. 2 because they are obscured).

Yet another limitation associated with three dimensional adorners is that portions of the adorner may sometimes appear distorted in size and shape. This distortion may be caused, for example, when the adorner is positioned too closely to a display camera or by other attributes of the adorner such as a small angle view. The term “display camera”, as used herein, refers to a theoretical camera with respect to which a three dimensional object is depicted in a display. The closer the adorner is positioned to the display camera, the more distorted the adorner may become, and, in some cases, the adorner may become almost unrecognizable. An exemplary distorted adorner is shown in FIG. 3. The portions of the distorted adorner which are closest to the display camera have an increased size and/or a distorted shape, most notably Z arrow portion 24c and Z axis portion 21c.

### SUMMARY

A three dimensional adorner may be displayed with a corresponding three dimensional object when the object is created or inserted into a display and also at any subsequent time that the object is selected. Additionally, if any portions of the adorner are obscured, the adorner may be reoriented such that the obscured portions are made accessible. To reorient the adorner, it may be determined which octant of the display is nearest to the display camera. A nearest set of three half axes that define the nearest octant may then be identified. One or more portions of the adorner that do not border the nearest set of three half axes may be removed from the adorner. One or more portions of the adorner that border the nearest set of three half axes may then be added to the adorner. The adorner may be reoriented in response to activation of a reorientation control, and the adorner may remain reoriented as long as the reorientation control is activated. Deactivation of the reorientation control may cause the adorner to return to its previous orientation.

Distortion of the three dimensional adorner in a perspective view may be reduced by removing the adorner from the perspective view, regenerating the adorner in an orthographic view, and then merging the orthographic view of the regenerated adorner with the perspective view of the corresponding object. To regenerate the adorner in the orthographic view, a display plane center point of the object may be calculated. A new origin point for the regenerated adorner may then be set to the display plane center point of the object. The orthographic view of the adorner may then be generated with the adorner extending from the new adorner origin point.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 depicts an exemplary prior art three dimensional adorner;

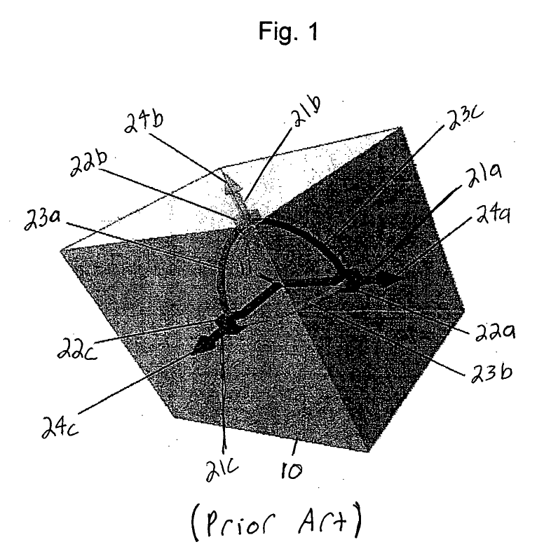

FIG. 2 depicts an exemplary prior art partially obscured three dimensional adorner;

FIG. 3 depicts an exemplary prior art distorted three dimensional adorner;

FIG. 4 depicts an exemplary method for reorienting a three dimensional adorner;

FIG. 5 depicts an exemplary reoriented three dimensional adorner;

FIG. 6 depicts an exemplary method for reducing distortion in a perspective view of a three dimensional adorner;

FIG. 7 depicts an exemplary perspective view of an object;

FIG. 8 depicts an exemplary orthographic view of an object;

FIG. 9 depicts an exemplary composite perspective and orthographic view; and

FIG. 10 is a block diagram representing an exemplary computing device.

### DETAILED DESCRPTION

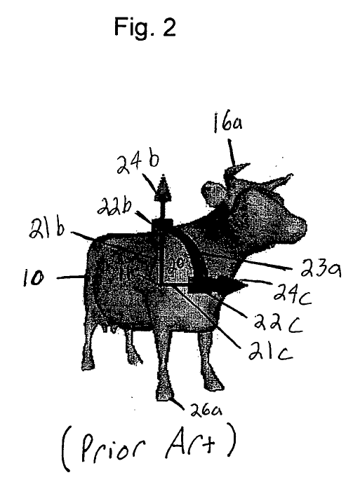

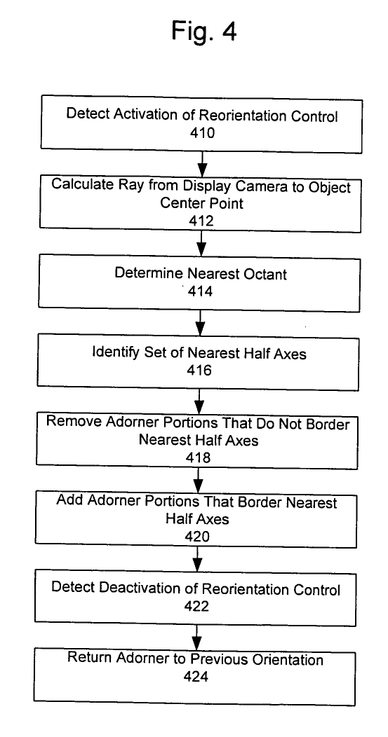

As described above with reference to FIG. 2, one of the limitations associated with conventional three dimensional adorners is that an object may become positioned such that one or more portions of its corresponding adorner are obscured, thereby making it difficult to perform the operations associated with those portions of the adorner. This limitation may be overcome by reorienting the adorner so that all portions of the adorner are accessible to a user. An exemplary method for reorienting a three dimensional adorner is depicted in FIG. 4. At act 410, an activation of a reorientation control is detected. The reorientation control may be, for example, a space bar key of an attached keyboard. The reorientation control may be activated by, for example, pressing down the space bar key. The reorientation control may also be referred to as an “accelerator key” or possibly another applicable name. The reorientation process need not necessarily be initiated by the activation of the reorientation control. For example, a three dimensional editing tool may detect that the certain portions of an adorner are obscured and initiate the reorientation process without first being prompted by a user.

At act 412, a ray is calculated that begins at a display camera and extends to a center point of the three dimensional object with which the adorner is associated. An actual ray need not necessarily be generated. Rather, it may be sufficient to simply calculate the path of a ray. As set forth above, the term “display camera” refers to a theoretical camera with respect to which the three dimensional object is depicted. The ray calculated at act 412 will cross through one or more octants of the object. Each octant of the object is defined by a unique set of three half axes extending from object center point 1. For example, referring back to the bull 10 depicted in FIG. 2, the bull's right horn 16a is in a “first” octant defined by the negative X, positive Y, and positive Z half axes. The bull's right front leg 26a is in a “second” octant defined by the negative X, negative Y, and positive Z half axes. As should be appreciated, there are six other octants of bull 10 which will not be defined in detail.

At act 414, a nearest octant is determined. The nearest octant is the octant of the object that is nearest to the display camera. The nearest octant may be determined by identifying the first octant through which the ray calculated at act 412 passes on its path from the display camera to the object center point 11. For example, referring back again to FIG. 2, bull 10 is vertically centered in the display. However, bull 10 angled towards the positive X axis and positive Y axis. Thus, the ray calculated at act 412 will extend along the border of the first octant that includes right horn 16a and the second octant that includes right front leg 26a. More specifically, the ray will extend along the bottom edge of the first octant and the top edge of the second octant. Thus, in the case of FIG. 2, either the first octant or the second octant may be selected as the nearest octant. For illustrative purposes, the first octant will be selected as the nearest octant.

At act 416, a set of three nearest half axes are identified. The set of nearest half axes is the unique set of three half axes which defines the nearest octant. As set forth above, the first octant is defined by the negative X, positive Y, and positive Z half axes. At act 418, portions of the adorner that do not border the nearest half axes are removed. For example, referring back again to FIG. 2, X axis portion 21a, X cube portion 22a, and X arrow portion 24a (not referenced in FIG. 2 because they are obscured) are positioned along the positive X axis. Thus, because the positive X axis is not one of the nearest half axes, X axis portion 21a, X cube portion 22a, and X arrow portion 24a will be removed from the positive X axis. By contrast, other portions of adorner 20 are positioned along the positive Y and positive Z half axes, which are both included in the set of nearest half axes. Thus, the portions of adorner 20 along the positive Y and positive Z half axes are not removed.

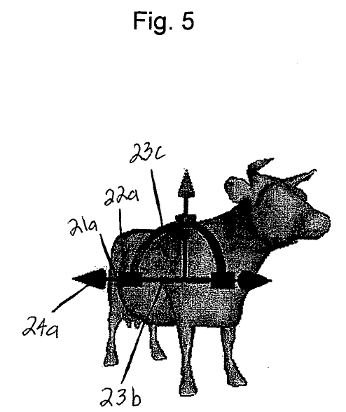

At act 420, to complete the reorientation of the adorner, portions of the adorner that border the nearest half axes are added. An exemplary reoriented adorner is shown in FIG. 5. As shown in FIG. 5, because the negative X axis is one of the nearest half axes, X axis portion 21a, X cube portion 22a, and X arrow portion 24a are added to the negative X axis. Also, because portions of the adorner have been added to the negative X axis, Y arc portion 23b and X arc portion 23c have been reoriented. In particular, Y arc portion 23b and Z arc portion 23c are both moved from the positive X axis to the negative X axis. Thus, all portions of the reoriented adorner of FIG. 5 are now visible and accessible.

At act 422, a deactivation of the reorientation control is detected, and, at act 424, the adorner is returned to its previous orientation. The adorner need not necessarily be returned to its previous orientation immediately after the reorientation control is deactivated. For example, the adorner may remain reoriented permanently or for a predetermined time period after the reorientation control is deactivated. Also, events other than deactivation of the reorientation control may cause the adorner to return to its previous orientation. Such events may include for example, detecting a portion of the adorner has been engaged and disengaged, detecting a repositioning of the object, and other events.

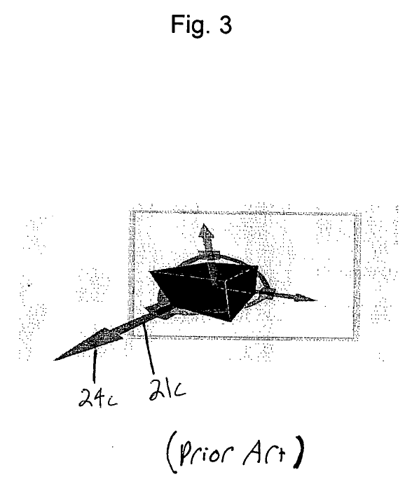

As described above with reference to FIG. 3, another of the limitations associated with a conventional three dimensional adorner is that a perspective view of the adorner may become distorted when the adorner is positioned too closely to a display camera. This limitation may be overcome by removing the adorner from the perspective view, regenerating the adorner in an orthographic view, and then merging the orthographic view of the regenerated adorner with the perspective view of the corresponding object. The merging may be accomplished using, for example, two dimensional compositing. The orthographic view of the regenerated adorner solves the perspective distortion problem because it causes the adorner to appear constant in size no matter how close the adorner is positioned to the display camera, and causes a distance, such as the length of an edge of the adorner, to remain constant in length, and the angle between the edges of the adorner to remain constant.

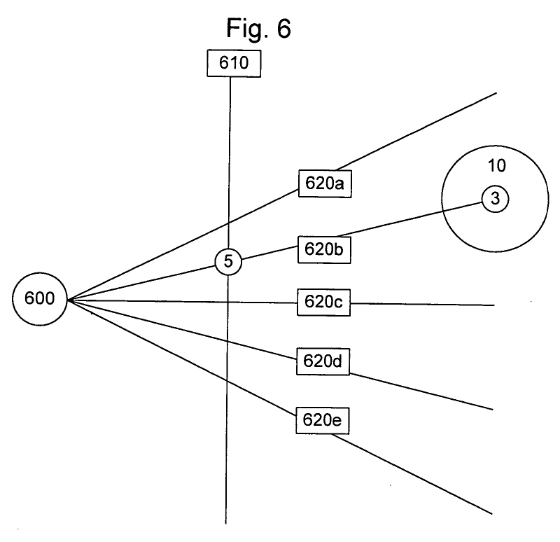

An exemplary perspective view of object 10 is depicted in FIG. 6. In the perspective view, light rays 620a-e funnel to display camera 600 as a function of spread angle. Also, object 10 is set back in object space from the display plane 610. Display plane 610 may be, for example, a screen of an attached computer monitor. As should be appreciated, the distance between object 10 and display plane 610 is not an actual difference but, rather, a theoretical difference that is depicted in the perspective view. The object space center point 3 of object 10 is positioned along light ray 620b. The display plane center point 5 of object 10 is the point on display plane 610 at which light ray 620b intersects with display plane 610. Due to the funneling of light ray 620b towards display camera 600, object space center point 3 is actually positioned vertically higher than display plane center point 5.

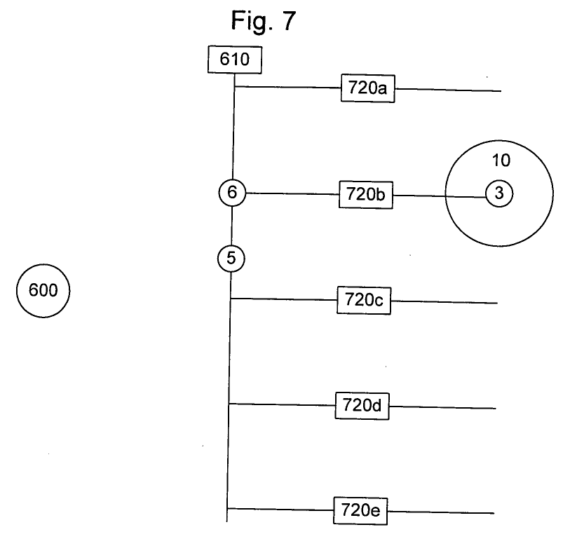

An exemplary orthographic view of object 10 is depicted in FIG. 7. In the orthographic view, light rays 720a-fall perpendicularly on display plane 610. For both the perspective view of FIG. 6 and the orthographic view of FIG. 7, objects close to display plane 610 or near the view's center line 620c/720c will be depicted at approximately the same point on the display plane 610. However, objects that are set further back in object space from display plane 610 or that are further away from center line 620c/720c will be depicted at divergent points on the display plane 610. To illustrate this concept, consider object 10, which is both set further back in object space from display plane 610 and is also further away from center line 620c/720c. As shown in FIG. 7, object 10 has an orthographic view display plane center point 6 which is positioned vertically higher than its corresponding perspective view display plane center point 5. Thus, to compensate for this divergence, some calculation is performed when an adorner is regenerated in an orthographic view. This calculation will be described in detail below.

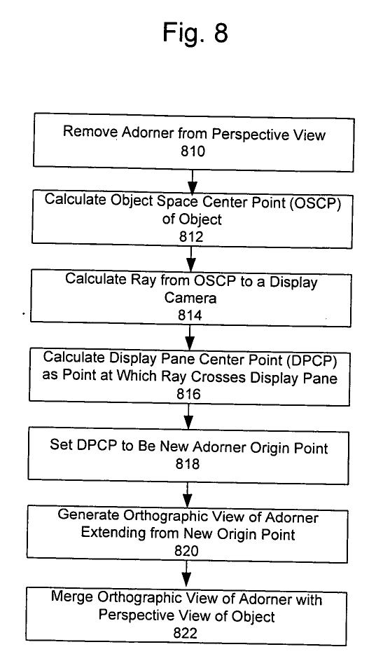

An exemplary method for reducing distortion in a perspective view of a three dimensional adorner is depicted in FIG. 8. At act 810, the adorner is removed from the perspective view, thereby leaving only the adorner's corresponding three dimensional object in the perspective view. At act 812, an object space center point of the object is calculated. At act 814, a ray is calculated from the object space center point to the perspective view display camera. An actual ray need not necessarily be generated. Rather, it may be sufficient to simply calculate the path of a ray. As described above with reference to FIG. 6, in the perspective view, the rays will funnel from the object to the display camera. At act 816, the object's display plane center point is calculated. The display plane center point is the point at which the ray calculated at act 814 intersects with the display plane. As also described above with reference to FIG. 6, the display plane center point will not be equivalent to the object space center point unless the object is either positioned on the display plane or the object is centered in the perspective view. The further the object is set back from the display plane, and the more off center the object is positioned, the greater the distance will be between the object space center point and the display plane center point.

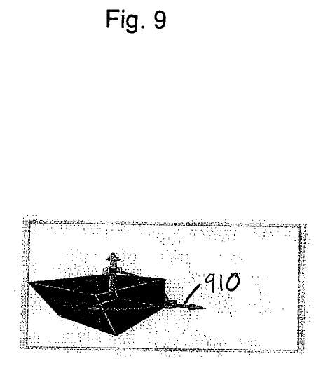

At act 818, the display plane center point of the object is set as the new origin point for the adorner. At act 820, the orthographic view of the adorner is generated with the adorner extending from he new adorner origin point. At act 822, the orthographic view of the regenerated adorner is merged with the perspective view of the object. The perspective and orthographic views may be merged using a windowing application program interface. An exemplary composite perspective and orthographic view is shown in FIG. 9. Unlike the perspective view of FIG. 3, the composite perspective and orthographic view of FIG. 9 includes a non-distorted regenerated adorner 910.

The regeneration of the adorner to remove distortion may be triggered by a number of possible events. For example, a user may determine that there is too much distortion in a perspective view of the adorner, and the user may request the regeneration of the adorner using a regeneration control. Alternatively, an editing tool may itself determine that there is more than a threshold amount of distortion in the perspective view and may launch the regeneration process without first being prompted by a user. This may occur whenever the adorner is placed at less than a threshold minimum distance from the display camera. Even if the editing tool itself determines that regeneration is desired, the editing tool may first consult the user prior to launching the regeneration process to ensure that such regeneration is desirable to the user.

Another limitation of conventional three dimensional adorners described above is that the adorner may only be displayed when its associated object is first created or inserted into a display. The adorner may then disappear and become inaccessible as soon as the creation step is complete. To overcome this limitation, the adorner may be displayed whenever its corresponding object has been selected by the user. The object may be selected using at least one input control such as an attached mouse and/or keyboard. For example, the object may be selected by clicking on the object using an attached mouse, thereby causing the adorner to reappear.

Attached input controls may also be used to perform a number of other enhanced transformation operations with respect to a three dimensional object. For example, using the mouse control to click on the object but off the adorner may cause the object to be translated in a direction corresponding to the movement of the mouse. Additionally, using the mouse in this manner while activating an arc ball rotation control may cause the object to be rotated in an arc ball fashion. The arc ball rotation control may be, for example, an “Alt” key on an attached keyboard. The “Alt” key may be activated by pressing down the key. Furthermore, activating an incremental rotation control while also activating an arc portion of the adorner may cause the object to be rotated by a predetermined increment. The predetermined increment may be, for example, a fifteen degree increment. The incremental rotation control may be, for example, an “Shift” key on an attached keyboard. The “Shift” key may be activated by pressing down the key.

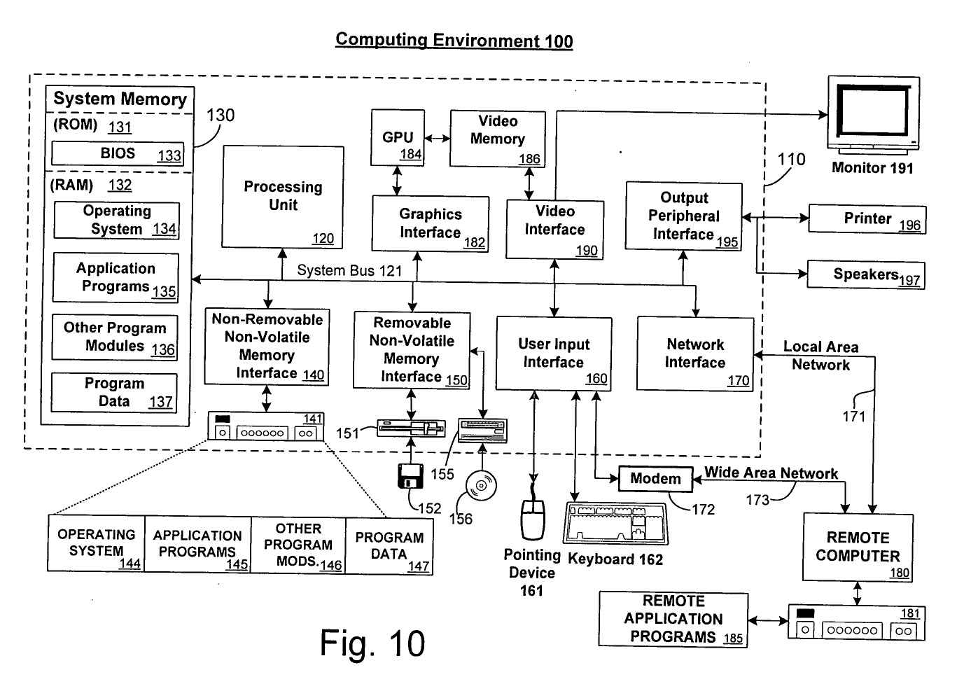

FIG. 10 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 10, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 10 illustrates operating system 134, application programs 135, other program modules 136, and program data 137.

The computer 110 may also include other removable/non-removable, volatile/nonvolatile computer storage media. By way of example only, FIG. 10 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 10 provide storage of computer readable instructions, data structures, program modules and other data for the computer 110. In FIG. 10, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 10. The logical connections depicted in FIG. 10 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 10 illustrates remote application programs 185 as residing on memory device 181. It will be appreciated that the network connections shown are exemplary and other means of establishing a communications link between the computers may be used.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A method for reorienting a three dimensional adorner in a display of a three dimensional object, the object having a set of octants, each octant defined by a unique set of three half axes extending from a center point of the object, the method comprising:
determining which of the octants is a nearest octant that is nearest to a display camera;
identifying a nearest set of three half axes that that define the nearest octant;
removing a portion of the adorner that does not border the nearest set of three half axes; and
adding a portion of the adorner that borders the nearest set of three half axes.

2. The method of claim 1, wherein determining which of the octants is the nearest octant comprises:
calculating path of a ray that originates from the display camera and extends to the center point of the object;
determining which of the octants is a first octant that the ray passes through first; and
setting the first octant to be the nearest octant.

3. The method of claim 1, further comprising:
reorienting the adorner in response to activation of a reorientation control; and
holding the adorner in a reoriented position as long as the reorientation control remains activated.

4. The method of claim 3, comprising:
reorienting the adorner in response to detecting that a space bar has been pressed down; and
holding the adorner in a reoriented position as long as the space bar remains pressed down.

5. The method of claim 1, wherein removing the portion of the adorner that does not border the nearest set of three half axes comprises:
removing an adorner axis portion that does not border the nearest set of three half axes; and
removing an adorner cube portion that does not border the nearest set of three half axes.

6. The method of claim 1, wherein adding the portion of the adorner that borders the nearest set of three half axes comprises:
adding an adorner axis portion that borders the nearest set of three half axes; and
adding an adorner cube portion that borders the nearest set of three half axes.

7. A computer readable medium having computer executable instructions for performing the steps recited in claim 1.

8. A method for reducing distortion in a perspective view of a three dimensional adorner and a corresponding three dimensional object, the method comprising:
removing the adorner from the perspective view;
calculating a display plane center point of the object;
setting the display plane center point to be a new adorner origin point;
generating an orthographic view of the adorner extending from the new adorner origin point; and
merging the orthographic view of the adorner with the perspective view.

9. The method of claim 8, wherein calculating the display plane center point comprises:
calculating an object space center point of the object;
calculating a path of a ray that originates from the object space center point and crosses through the display plane to extend to a display camera; and
setting the display plane center point to be a point on the display plane at which the path of the ray crosses through the display plane.

10. The method of claim 8, further comprising determining that the adorner is displayed in the perspective view with more than a threshold amount of allowable distortion, and, in response, generating the orthographic view.

11. The method of claim 10, wherein determining that the adorner is displayed in the perspective view with more than a threshold amount of allowable distortion comprises receiving a user request to reduce distortion.

12. The method of claim 10, wherein determining that the adorner is displayed in the perspective view with more than a threshold amount of allowable distortion comprises determining that a portion of the adorner is less than a threshold minimum distance from a display camera.

13. A computer readable medium having computer executable instructions for performing the steps recited in claim 8.

14. A system for displaying and manipulating a three dimensional object, the system comprising:
an input device that enables the object to be manipulated; and
a display for displaying the object and an associated three dimensional adorner that is available whenever the object is selected.

15. The system of claim 14, wherein the input device is an attached mouse.

16. The system of claim 15, wherein the mouse enables the object to be manipulated in the display by using the mouse to click on the object without clicking on the adorner.

17. The system of claim 14, wherein the input device comprises an arc ball rotation control that enables the object to be rotated in an arc ball fashion.

18. The system of claim 17, wherein the arc ball rotation control is an alt key on an attached keyboard.

19. The system of claim 14, wherein the input device comprises an incremental rotation control that enables the object to be rotated by a predetermined increment.

20. The system of claim 19, wherein the incremental rotation control is a shift key on an attached keyboard.
